(19) United States
(12) Patent Application Publication
(10) Pub. No.: US 2013/0156337 A1
(43) Pub. Date: Jun. 20, 2013

(54) METHOD FOR REMOVING NOISE OF IMAGE

(71) Applicants: Tae Hyeon Kwon, Gyeonggi-do (KR); In Taek Song, Gyeonggi-do (KR); Kyoung Joong Min, Seoul (KR)

(72) Inventors: Tae Hyeon Kwon, Gyeonggi-do (KR); In Taek Song, Gyeonggi-do (KR); Kyoung Joong Min, Seoul (KR)

(21) Appl. No.: 13/420,535

(22) Filed: Mar. 14, 2012

(30) Foreign Application Priority Data
Dec. 19, 2011 (KR) 10-2011-0137425

(51) Int. Cl. G06K 9/40

(52) U.S. Cl. 382/264

(57) ABSTRACT

A method for removing noise of an image. The method includes: (a) detecting a horizontal edge by applying a horizontal edge detection filter to a predetermined pixel field including a notice pixel and neighboring pixel in a vertical direction in image data; (b) judging whether horizontal line noise exists in the predetermined pixel field through the horizontal edge; (c) calculating the number of pixels determined as the horizontal line noise for each horizontal line of the image data by applying steps (a) and (b) to all horizontal lines of the image data; and (d) removing the horizontal line noise by applying a low pass filter to the horizontal line judged to have the horizontal line noise according to the calculation result of step (c).

### CROSS REFERENCE(S) TO RELATED APPLICATIONS

This application claims the benefit under 35 U.S.C. Section 119 of Korean Patent Application Serial No. 10-2011-0137425, entitled “Method for Removing Noise of Image” filed on Dec. 19, 2011, which is hereby incorporated by reference in its entirety into this application.

### BACKGROUND OF THE INVENTION

1. Technical Field

The present invention relates to a method for removing noise of an image, and more particularly, to a method for removing noise of an image that can selectively remove or reduce horizontal line noise generated in a low illuminance environment while maintaining definition of the image to provide a high-quality image particularly in a night environment.

2. Description of the Related Art

In a recent automobile technology, various systems in which cameras are installed at left and right sides as well as front and rear sides of an automobile to view images through a display of an instrument panel of a driver seat have been researched and developed in order to improve driver's convenience and safety and have already started being adopted. As one of the systems, a Night Vision System (NVS) which is a device for assisting driver's visibility when a vehicle is driven in a dark environment like night driving irradiates infrared rays to the front of the vehicle, photographs the front with a camera, and provide images to a driver to allow the driver to detect an obstacle or a pedestrian in front of the vehicle, thereby ensuring driver's safety driving and preventing a traffic accident.

At present, a vehicular camera has much lower image quality than a digital camera due to circuital problems such as power consumption, memory and logic limitations, and the like, problems associated with a camera module such as optical zoom, autofocus, and resolution limitation, and the like and in particular, even though the NVS uses a wide dynamic range (WDR) sensor, the NVS generates a large amount of low-illuminance noise and has remarkable low image brightness, and as a result, it is not easy to recognize an object in the NVS. Therefore, an algorithm for removing noise from a night image of a night vision camera and improving the image quality is required.

As noise removing methods in a digital image processing apparatus, various methods were proposed in the related art, but considerations of a brightness value of the image or a direction of an edge and a pattern of noise are not appropriately adopted, and as a result, the image is blurred or the edge is damaged.

As the simplest method for reducing a noise component included in an image signal, a method for removing noise by applying a low pass filter (LPF) to a notice pixel and a neighboring pixel is provided. However, when the LPF is applied to all image pixels, edge information required to identify an object is also reduced as well as the noise component of the image, and as a result, the definition of the image decreases and the image quality deteriorates.

FIG. 1 is a diagram showing an image outputted from a Night Vision System in the related art. Referring to FIG. 1, in the output image outputted from the Night Vision System, a bright field 10 around a road which is lit up by a headlight of a vehicle and a remarkably dark field on the top of the image are displayed simultaneously, and as a result, due to a characteristic in which distributions and intensities of noise generated from the respective fields are different from each other, the noise cannot be effectively removed and the definition of the image cannot be conserved by using the noise removing method in the related art.

In particular, the image outputted from the Night Vision System includes a larger amount of noise than a general image and has a characteristic in that the brightness value of the image is remarkably low. Therefore, a method capable of effectively reducing or removing the horizontal line noise while not reducing the definition and quality of the image is required.

### SUMMARY OF THE INVENTION

An object of the present invention is to provide a method for removing noise of an image that can selectively remove or reduce horizontal line noise generated in a low illuminance environment while maintaining definition of the image to provide a high-quality image particularly in a night environment.

According to an exemplary embodiment of the present invention, there is provided a method for removing noise of an image, including: (a) detecting a horizontal edge by applying a horizontal edge detection filter to a predetermined pixel field including a notice pixel and neighboring pixel in a vertical direction in image data; (b) judging whether or not horizontal line noise exists in the predetermined pixel field through the horizontal edge; (c) calculating the number of pixels determined as the horizontal line noise for each horizontal line of the image data by applying steps (a) and (b) to all horizontal lines of the image data; and (d) removing the horizontal line noise by applying a low pass filter to the horizontal line judged to have the horizontal line noise according to the calculation result of step (c).

Step (a) may include calculating absolute deviation values (dv(i), 0=i<5) corresponding to a field of the horizontal edge detection filter by applying the horizontal edge detection filter using a Laplacian kernel to the predetermined pixel field in a vertical direction as shown in the following equation

dv(0)=|2·P1−P0−P2|

dv(1)=|2·P2−P1−P3|

dv(2)=|2·P3−P2−P4|

dv(3)=|2·P4−P3−P5|

dv(4)=|2·P5−P4−P6|.

In this case, when the calculated absolute deviation values are equal to or more than a first threshold, the horizontal edge may be detected and when the horizontal edge is detected, the predetermined pixel field may be judged to have a horizontal contour or horizontal line noise.

Step (b) may include judging whether the horizontal line noise exists in accordance with the number of the horizontal edges detected in the predetermined pixel field.

In this case, when the number of the horizontal edges detected in the predetermined pixel field is three or more, the predetermined pixel field may be judged to have the horizontal line noise including the notice pixel.

Step (c) may include determining the notice pixel of the predetermined pixel field having the horizontal line noise as a pixel determined by the horizontal line noise and calculating the number of the determined pixels for each horizontal line of the image data.

In this case, the horizontal line in which the number of the determined pixels is equal to or more than a second threshold among the horizontal lines of the image data may be judged as the horizontal line having the horizontal line noise.

Step (d) may include applying the low pass filter to all pixels included in the horizontal line judged to have the horizontal line noise.

In this case, the low pass filter may be applied sequentially in the vertical direction of the image data.

Meanwhile, in step (d), the horizontal line noise may be removed by selectively applying the low pass filter to only a pixel corresponding to a dark field in accordance with an average brightness value AVG(BR) of the neighboring pixels among all the pixels included in the horizontal line judged to have the horizontal line noise as shown in the following equation

AVG(BR)=(P1+P2+P4+P5)/4.

In this case, the low pass filter may be applied to only a pixel in which the average brightness value of the neighboring pixels is equal to or less than a third threshold.

Meanwhile, the predetermined pixel field may be constituted by seven pixels or more including the notice pixel and the neighboring pixels.

### BRIEF DESCRIPTION OF THE DRAWINGS

FIG. 1 is a photograph showing an image outputted from a Night Vision System in the related art;

FIG. 2 is a block diagram schematically showing a method for removing noise of an image according to an exemplary embodiment of the present invention;

FIG. 3 is a flowchart schematically showing an operational flow of the method for removing noise of an image according to the exemplary embodiment of the present invention;

FIG. 4 is a diagram showing a predetermined pixel field and a horizontal edge detecting filter of the method for removing noise of an image according to the exemplary embodiment of the present invention;

FIGS. 5A to 5E are diagrams for showing a method for detecting a horizontal edge in various edge types of a predetermined pixel field in the method for removing noise of an image according to the exemplary embodiment of the present invention;

FIG. 5A shows that only a notice pixel of a predetermined pixel field is an edge;

FIG. 5B shows that the notice pixel and one neighboring pixel adjacent thereto of the predetermined pixel field are edges;

FIG. 5C shows that the notice pixel and two neighboring pixels adjacent thereto of the predetermined pixel field are edges;

FIG. 5D shows that the notice pixel and three neighboring pixels adjacent thereto of the predetermined pixel field are edges;

FIG. 5E shows that the notice pixel and four neighboring pixels adjacent thereto of the predetermined pixel field are edges;

FIG. 6 is a diagram schematically showing accumulation of the number pixels determined as horizontal line noise for each horizontal line of image data through a histogram according to the method for removing noise of an image according to the exemplary embodiment of the present invention; and

FIG. 7 is a photograph showing an image implemented through the method for removing noise of an image according to the exemplary embodiment of the present invention.

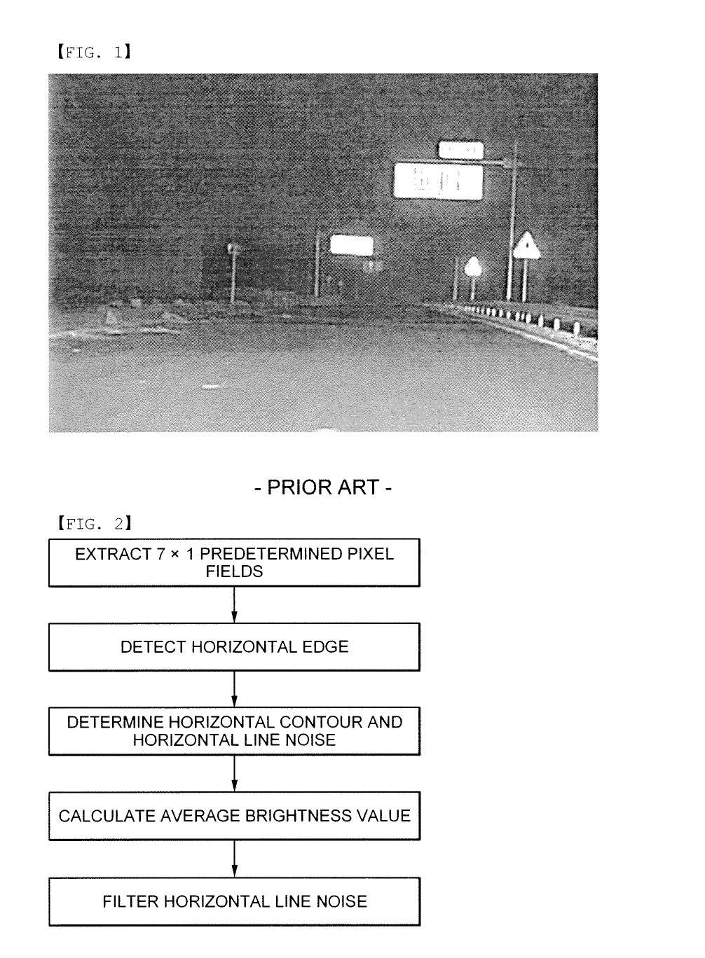

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

In addition, the exemplary embodiments of the present invention will be described with reference to cross-sectional views and/or plan views, which are exemplary views of the present invention. In the drawings, thicknesses of films and regions may be exaggerated for efficiently explaining the technical contents of the present invention. Therefore, the forms of the exemplary views may be modified by manufacturing techniques and/or allowable errors, etc. Therefore, the embodiments of the present invention are not limited to the specific forms illustrated in the drawings but may include changes in forms generated according to the manufacturing processes. For example, an etched region illustrated to be orthogonal may also have a shape to be rounded or having a certain curvature. Therefore, the regions illustrated in the drawings have schematic attributes and the shapes of the regions illustrated in the drawings are not for limiting the scope of the invention but for illustrating a certain shape of a device.

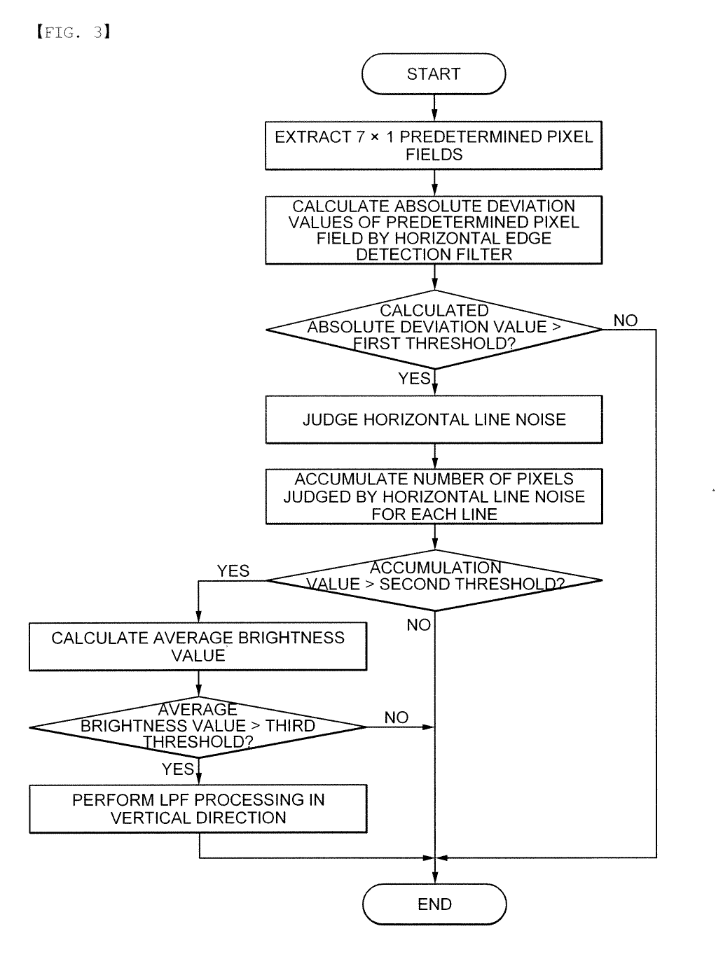

Hereinafter, a method for removing noise of an image according to an exemplary embodiment of the present invention will be described in detail with reference to FIGS. 2 to 7.

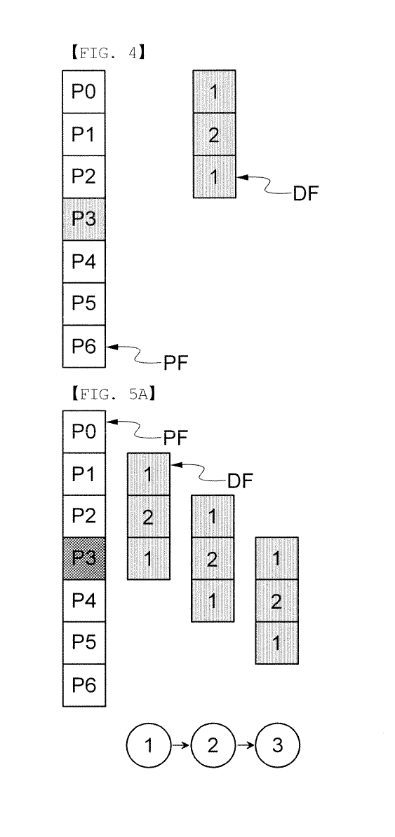

FIG. 2 is a block diagram schematically showing a method for removing noise of an image according to an exemplary embodiment of the present invention. FIG. 3 is a flowchart schematically showing an operational flow of the method for removing noise of an image according to the exemplary embodiment of the present invention. FIG. 4 is a diagram showing a predetermined pixel field and a horizontal edge detection filter of the method for removing noise of an image according to the exemplary embodiment of the present invention.

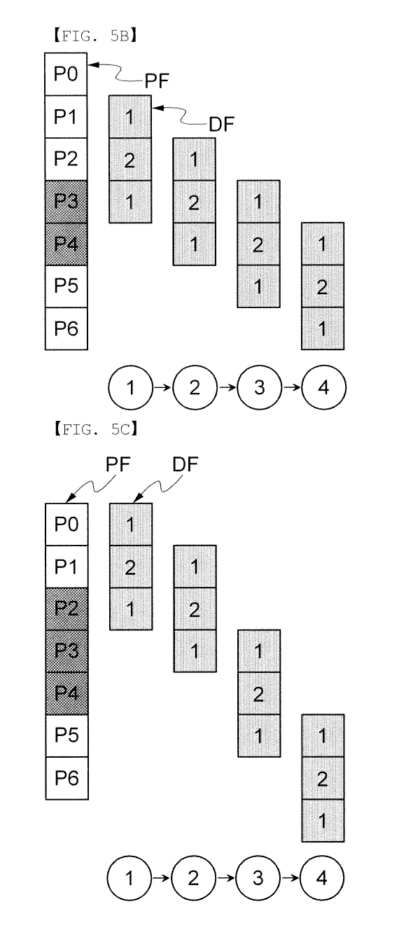

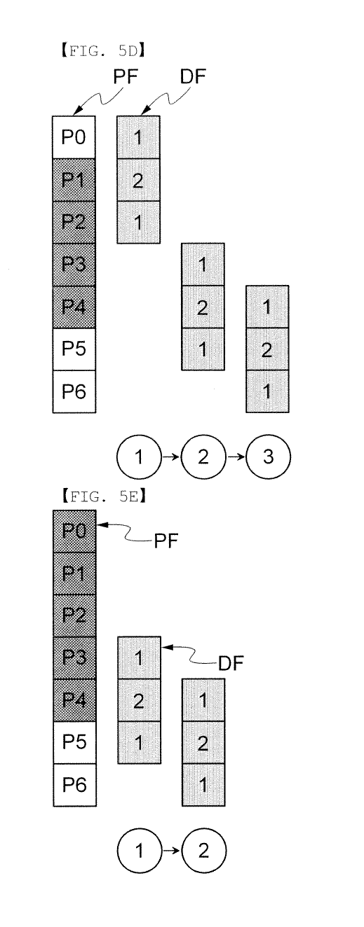

In addition, FIGS. 5A to 5E are diagrams for showing a method for detecting a horizontal edge in various edge types of a predetermined pixel field in the method for removing noise of an image according to the exemplary embodiment of the present invention. FIG. 5A shows that only a notice pixel of a predetermined pixel field is an edge. FIG. 5B shows that the notice pixel and one neighboring pixel adjacent thereto of the predetermined pixel field are edges. FIG. 5C shows that the notice pixel and two neighboring pixels adjacent thereto of the predetermined pixel field are edges. FIG. 5D shows that the notice pixel and three neighboring pixels adjacent thereto of the predetermined pixel field are edges. FIG. 5E shows that the notice pixel and four neighboring pixels adjacent thereto of the predetermined pixel field are edges.

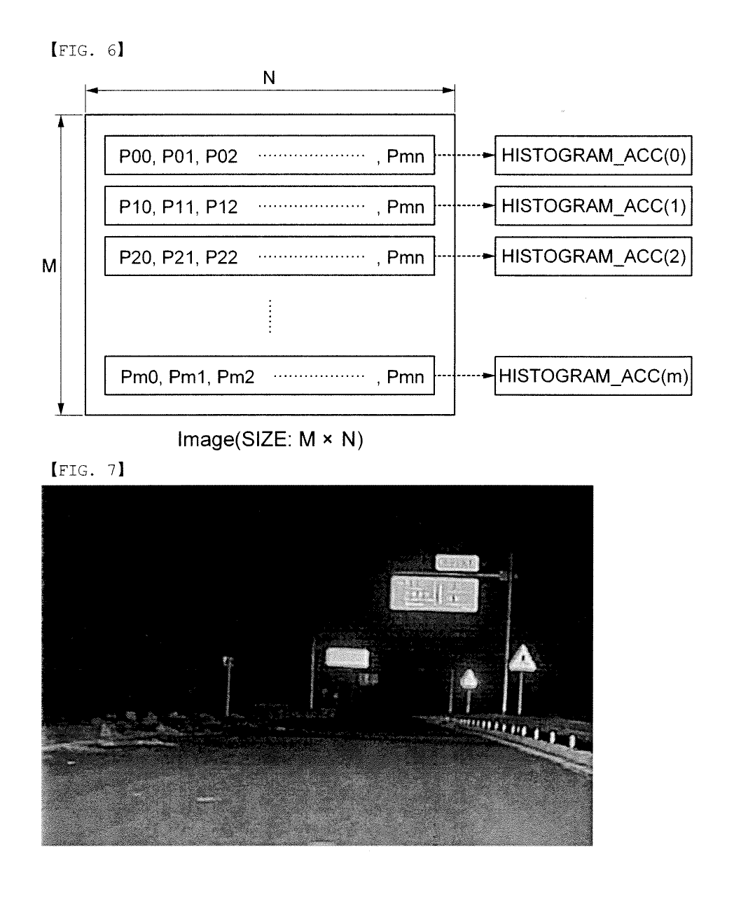

Further, FIG. 6 is a diagram schematically showing accumulation of the number pixels determined as horizontal line noise for each horizontal line of image data through a histogram according to the method for removing noise of an image according to the exemplary embodiment of the present invention. FIG. 7 is a photograph showing an image implemented through the method for removing noise of an image according to the exemplary embodiment of the present invention.

Referring to FIGS. 2 and 3, in the method for removing noise of an image according to the exemplary embodiment of the present invention, first, image data outputted from an image sensor of a camera is acquired.

In this case, the image data outputted from the image sensor may be a data value for luminance and may be stored in a line memory capable of storing data by the unit of predetermined lines or more.

Thereafter, a predetermined pixel field including a notice pixel and a neighboring pixel is extracted vertically from the image data to apply a horizontal edge detection filter using a Laplacian kernel to the predetermined pixel field in a vertical direction.

In this case, as shown in FIG. 4, the predetermined pixel field PF of the exemplary embodiment may be constituted by seven vertical pixels including neighboring pixels P0, P1, P2, P4, P5, and P6 in the vertical direction based on the notice pixel P3, that is, 7×1 field and the horizontal edge detection filter DF may be constituted by 3×1 field which are smaller than the predetermined pixel field PF, but the constitution of the horizontal edge detection filter DF is not limited thereto.

Herein, when the horizontal edge detection filter using the Laplacian kernel is applied to the predetermined pixel field in the vertical direction, an absolute deviation value (dv(i), 0=i<5) corresponding to the field of the horizontal edge detection filter is calculated by Equation 1 below to detect a horizontal edge of the predetermined pixel field.

dv(0)=|2·P1−P0−P2|

dv(1)=|2·P2−P1−P3|

dv(2)=|2·P3−P2−P4|

dv(3)=|2·P4−P3−P5|

dv(4)=|2·P5−P4−P6| [Equation 1]

In addition, each of the calculated absolute deviation values (dv(0), dv(1), dv(2), dv(3), and dv(4)) is compared with a first threshold and when the absolute deviation values are equal to or more than the first threshold, it may be judged that the horizontal edge is detected.

In this case, when the horizontal edge is detected, it may be judged that the predetermined pixel field has a horizontal contour or horizontal line noise.

In the exemplary embodiment, when the horizontal edge is detected in the predetermined pixel field, whether the predetermined pixel field has the horizontal contour or the horizontal line noise may be determined through the number of the horizontal edges.

That is, whether a type of the edge which exists in the predetermined pixel field is the horizontal contour or the horizontal noise may be determined through the absolute deviation value which is equal to or more than the first threshold among the calculated absolute deviation values (dv(0), dv(1), dv(2), dv(3), and dv(4)), that is, the number of the horizontal edges detected in the predetermined pixel field.

More specifically, as shown in FIGS. 5A to 5E, the type of the edge that exists in the predetermined pixel field PF may be distinguished based on at least the thickness of the pixel including the notice pixel P3 and the number of the horizontal edges detected from the predetermined pixel field PF may be used in order to distinguish the type of the edge.

First, as shown in FIG. 5A, when the predetermined pixel field PF has the type of the edge including the notice pixel P3, the number of the horizontal edges detected by applying the horizontal edge detection filter DF to the predetermined pixel field PF may be three. That is, the number of the absolute deviation values which are equal to or more than the first threshold among the absolute deviation values calculated by applying the horizontal edge detection filter DF to the predetermined pixel field PF may be three.

In addition, as shown in FIG. 5B, when the predetermined pixel field PF has the type of the edge including the notice pixel P3 and the neighboring pixel P4, the number of the horizontal edges detected by applying the horizontal edge detection filter DF to the predetermined pixel field PF may be four.

Moreover, as shown in FIG. 5C, when the predetermined pixel field PF has the type of the edge including the notice pixel P3 and the neighboring pixels P2 and P4, the number of the horizontal edges detected by applying the horizontal edge detection filter DF to the predetermined pixel field PF may be four.

Moreover, as shown in FIG. 5D, when the predetermined pixel field PF has the type of the edge including the notice pixel 23 and the neighboring pixels P1, P2, and P4, the number of the horizontal edges detected by applying the horizontal edge detection filter DF to the predetermined pixel field PF may be three.

In addition, as shown in FIG. 5E, when the predetermined pixel field PF has the type of the edge including the notice pixel P3 and the neighboring pixels P0, P1, P2, and P4, the number of the horizontal edges detected by applying the horizontal edge detection filter DF to the predetermined pixel field PF may be two.

Herein, when the notice pixel of the predetermined pixel field PF is included in the horizontal contour of a predetermined object, the type of the edge of the predetermined pixel field PF may have a thick type, that is, the type of the edge including the notice pixel P3 and the neighboring pixels P0, P1, P2, and P4 as shown in FIG. 5E and in this case, the number of the horizontal edges may be detected as two or less.

Relatively, when the notice pixel of the predetermined pixel field PF is included in the horizontal line noise, the number of the horizontal edges of the predetermined pixel field PF may be detected as three or more.

Thereafter, the detection process of the horizontal edge and the detection process of the horizontal line noise by the number of the horizontal edges are applied to all horizontal lines of the image data to calculate the number of pixels determined as the horizontal line noise for each horizontal line of the image data, that is, the number of the notice pixels.

As one example, referring to FIG. 6, the detection process of the horizontal edge and the detection process of the horizontal line noise by the number of the horizontal edges are performed in image data having M horizontal lines and N vertical lines to judge a notice pixel of a predetermined pixel field having the horizontal line noise as the pixel determined as the horizontal line noise and thereafter, calculate the number of the pixels determined as the horizontal line noise for each of the M horizontal lines, and accumulate (HISTOGRAM_ACC(i), 0≦i≦M) the calculated pixel number through a histogram and store the accumulated number.

Thereafter, as a calculation result of the number of the pixels determined as the horizontal line noise, when the number of the pixels determined as the horizontal line noise among M horizontal lines of the image data is equal to or more than a second threshold, it may be judged that the corresponding horizontal lines have the horizontal line noise and a low pass filter is applied to the horizontal lines judged to have the horizontal line noise to remove the horizontal line noise.

Herein, the low pass filter is applied to all pixels included in the horizontal lines judged to have the horizontal line noise to remove the horizontal line noise on the horizontal line.

In this case, the low pass filter may be sequentially applied in the vertical direction of the image data and the low pass filter is applied to the horizontal line having the horizontal line noise among all the horizontal lines of the image data to remove the horizontal line noise.

Meanwhile, in the exemplary embodiment, the Low pass filter is applied to only a low-illuminance field in the image data to selectively remove only the horizontal line noise generated in the low-illuminance field, thereby implementing high quality of the image while maintaining the definition of the image implemented due to the image data.

More specifically, the low pass filter is selectively applied to only a pixel corresponding to a field having a low average brightness value (AVG(BR)) of a neighboring pixel, that is, a dark field by Equation 2 below among all pixels included in the horizontal line judged to have the horizontal line noise to remove the horizontal line noise.

AVG(BR)=(P1+P2+P4+P5)/4 [Equation 2]

That is, the average brightness value (AVG(BR)) of the neighboring pixels P1, P2, P4 and P5 of each pixel P3 included in the horizontal line judged to have the horizontal line noise is calculated and the low pass filter may be applied to only a pixel of which the calculated average brightness value (AVG(BR)) is equal to or less than a third threshold.

Accordingly, according to the exemplary embodiment, the low pass filter is applied to only dark pixels to selectively remove only the horizontal line noise generated in a dark, that is, low-illuminance field of an image photographed in a low-illuminance environment, and as a result, as shown in FIG. 7, the high-quality image can be provided in a night photographing environment while conserving the definition of the image.

As set forth above, according to the method for removing noise of an image according to the exemplary embodiment of the present invention, the horizontal line noise can be easily and accurately detected through the horizontal edge, and as a result, the horizontal line noise is effectively removed, thereby improving the definition and quality of the image.

In addition, according to the method for removing noise of an image according to the exemplary embodiment of the present invention, since only the horizontal line noise in the low-illuminance field can be effectively removed, the high-quality image can be provided while the definition of the image in the bright field is maintained.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for removing noise of an image, comprising:
(a) detecting a horizontal edge by applying a horizontal edge detection filter to a predetermined pixel field including a notice pixel and neighboring pixel in a vertical direction in image data;
(b) judging whether horizontal line noise exists in the predetermined pixel field through the horizontal edge;
(c) calculating the number of pixels determined as the horizontal line noise for each horizontal line of the image data by applying steps (a) and (b) to all horizontal lines of the image data; and
(d) removing the horizontal line noise by applying a low pass filter to the horizontal line judged to have the horizontal line noise according to the calculation result of step (c).

2. The method for removing noise of an image according to claim 1, wherein step (a) includes calculating absolute deviation values (dv(i), 0=i<5) corresponding to a field of the horizontal edge detection filter by applying the horizontal edge detection filter using a Laplacian kernel to the predetermined pixel field in a vertical direction as shown in the following equation
dv(0)=|2·P1−P0−P2|

dv(1)=|2·P2−P1−P3|

dv(2)=|2·P3−P2−P4|

dv(3)=|2·P4−P3−P5|

dv(4)=|2·P5−P4−P6|.

3. The method for removing noise of an image according to claim 2, wherein when the calculated absolute deviation values are equal to or more than a first threshold value, the horizontal edge is detected and when the horizontal edge is detected, the predetermined pixel field is judged to have a horizontal contour or horizontal line noise.

4. The method for removing noise of an image according to claim 1, wherein step (b) includes judging whether the horizontal line noise exists in accordance with the number of the horizontal edges detected in the predetermined pixel field.

5. The method for removing noise of an image according to claim 4, wherein when the number of the horizontal edges detected in the predetermined pixel field is three or more, the predetermined pixel field is judged to have the horizontal line noise including the notice pixel.

6. The method for removing noise of an image according to claim 1, wherein step (c) includes determining the notice pixel of the predetermined pixel field having the horizontal line noise as a pixel determined by the horizontal line noise and calculating the number of the determined pixels for each horizontal line of the image data.

7. The method for removing noise of an image according to claim 6, wherein the horizontal line in which the number of the determined pixels is equal to or more than a second threshold among the horizontal lines of the image data is judged as the horizontal line having the horizontal line noise.

8. The method for removing noise of an image according to claim 1, wherein step (d) includes applying the low pass filter to all pixels included in the horizontal line judged to have the horizontal line noise.

9. The method for removing noise of an image according to claim 8, wherein the low pass filter is applied sequentially in the vertical direction of the image data.

10. The method for removing noise of an image according to claim 1, wherein in step (d), the horizontal line noise is removed by selectively applying the low pass filter to only a pixel corresponding to a dark field in accordance with an average brightness value AVG(BR) of the neighboring pixels among all the pixels included in the horizontal line judged to have the horizontal line noise as shown in the following equation
AVG(BR)=(P1+P2+P4+P5)/4.

11. The method for removing noise of an image according to claim 10, wherein the low pass filter is applied to only a pixel in which the average brightness value of the neighboring pixels is equal to or less than a third threshold.

12. The method for removing noise of an image according to claim 1, wherein the predetermined pixel field is constituted by seven pixel or more including the notice pixel and the neighboring pixels.
